(19) United States
(12) Patent Application Publication
(10) Pub. No.: US 2026/0161049 A1
(43) Pub. Date: Jun. 11, 2026

(54) OPTICAL MEMBER DRIVING MECHANISM

(71) Applicant: TDK CORPORATION, Tokyo (JP)

(72) Inventors: Chuan-Min LEE, Taoyuan City (TW); Chao-Chang HU, Taoyuan City (TW); Shu-Shan CHEN, Taoyuan City (TW); Pai-Jui CHENG, Taoyuan City (TW)

(73) Assignee: TDK CORPORATION, Tokyo (JP)

(21) Appl. No.: 19/181,013

(22) Filed: Apr. 16, 2025

Related U.S. Application Data
(60) Provisional application No. 63/639,384, filed on Apr. 26, 2024.

(51) Int. Cl. G03B 9/06

(52) U.S. Cl. CPC G03B 9/06; G03B 2205/0061

(57) ABSTRACT

An optical member driving mechanism is provided, including a movable portion, a fixed portion, and a driving assembly. The movable portion is configured to connect an optical member, and the movable portion is movable relative to the fixed portion. The driving assembly is configured to drive the movable portion to move.

### CROSS REFERENCE TO RELATED APPLICATIONS

This application claims the benefit of U.S. Provisional Application No. 63/639,384, filed Apr. 26, 2024, the entirety of which is incorporated by reference herein.

### BACKGROUND OF THE INVENTION

### Field of the Invention

The application relates in general to an optical member driving mechanism, and in particular it relates to an optical member driving mechanism that is able to adjust the size of the aperture.

### Description of the Related Art

As relevant technologies have been developed and improved, many electronic devices (such as cameras and smartphones) can record images and videos. However, when a lens having a long focal length is installed in the electronic device, it may increase the thickness of the device, which can adversely impede the prospects for miniaturizing the electronic device. Furthermore, conventional micro image capturing modules are mainly designed to have an aperture with a fixed diameter, and the image sharpness and photosensitivity of most small mobile electronic devices are not adjustable. A smaller aperture is required to achieve better image quality (if the sensor supports it and if there is enough light). However, if the size of the aperture is fixed and has a small size, image quality will be low when there is not enough light (e.g. at night). As a result, the image capturing ability under different environments will be sacrificed if the diameter of the aperture is fixed.

### BRIEF SUMMARY OF INVENTION

An embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

In some embodiments, the driving assembly includes a piezoelectric member, the piezoelectric member is deformed along a first axis when operating, and the driving assembly drives the movable portion to rotate around a second axis, wherein the second axis is different from the first axis.

In some embodiments, the second axis is substantially perpendicular to the first axis.

In some embodiments, the driving assembly further includes a weight member and a transmitting member. The weight member is disposed on the fixed portion. The piezoelectric member is disposed between the weight member and the transmitting member, the piezoelectric member is connected to the weight member, and the transmitting member is connected to the piezoelectric member. The optical member driving mechanism further includes a pressing assembly. The pressing assembly is connected to the fixed portion and in contact with the transmitting member. The pressing assembly provides a pushing force to put the transmitting member in contact with the movable portion.

In some embodiments, the direction of the pushing force is different from the first axis and the second axis.

In some embodiments, the direction of the pushing force is substantially perpendicular to the first axis and the second axis.

In some embodiments, the pressing assembly includes a pressing member. The pressing member includes a first fixing end, a second fixing end, and a contact section. The first fixing end and the second fixing end are connected to the fixed portion. The contact section is in contact with the transmitting member, wherein in the first axis, the contact section is situated between the first fixing end and the second fixing end.

In some embodiments, the pressing assembly includes a pressing member, the pressing member includes a first fixing end, a second fixing end, and a contact section, the first fixing end and the second fixing end are connected to the fixed portion, and the contact section is in contact with the transmitting member, wherein in the second axis, the contact section is situated between the first fixing end and the second fixing end.

In some embodiments, the first fixing end and the second fixing end are movably connected to the fixed portion.

In some embodiments, the pressing assembly further includes a ball member that is in contact with the contact section and the fixed portion.

In some embodiments, the transmitting member has a circular cross-section, and the pressing assembly has a flat surface that is in contact with the transmitting member.

In some embodiments, the transmitting member includes a first end and a second end, the first end is connected to the piezoelectric member, the second end is opposite to the first end, and a gap is formed between the second end and the fixed portion.

In some embodiments, the optical member driving mechanism further includes a soft member connected to the transmitting member and the fixed portion. The soft member is disposed between the first end and the second end.

In some embodiments, the movable portion has a concave structure. The concave structure has an arc-shaped cross-section. The radius of curvature of the arc-shaped cross-section of the concave structure is greater than the radius of curvature of the transmitting member.

In some embodiments, the movable portion has a first inclined surface and a second inclined surface, an included angle is formed between the first inclined surface and the second inclined surface, and the included angle is less than 180 degrees. The transmitting member is in contact with the first inclined surface at a point of contact, and the transmitting member is in contact with the second inclined surface at another point of contact.

In some embodiments, the movable portion has a contact surface, the contact surface is parallel to the second axis, and the transmitting member is in contact with the contact surface at a point of contact.

In some embodiments, the movable portion includes a rotary member and at least two positioning balls, and the positioning balls are connected to the fixed portion and the rotary member.

In some embodiments, the optical member driving mechanism further includes a plurality of soft members that are in contact with the positioning balls and the fixed portion.

In some embodiments, the movable portion includes a rotary member and a bearing, and the bearing is connected to the fixed portion and the rotary member.

In some embodiments, the optical member driving mechanism further includes a position sensing assembly, and the position sensing assembly includes an annular magnetic member, a circuit board, and a sensor. The annular magnetic member is connected to the movable portion. The circuit board is disposed on the fixed portion. The sensor is disposed on the circuit board and situated at a side of the annular magnetic member, wherein the fixed portion has an opening, and the annular magnetic member and the sensor are exposed from the opening.

### BRIEF DESCRIPTION OF DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a schematic diagram of an optical member driving mechanism according to an embodiment of the invention;

FIG. 2 is an exploded-view diagram of the optical member driving mechanism according to an embodiment of the invention;

FIG. 3 is a cross-sectional view taken along the line A-A in FIG. 2;

FIG. 4 is a cross-sectional view taken along the line B-B in FIG. 2;

FIG. 5 is a cross-sectional view taken along the line C-C in FIG. 2;

FIG. 6A is a cross-sectional view taken along the line D-D in FIG. 2;

FIG. 6B is a schematic diagram of an optical member driving mechanism according to another embodiment of the invention;

FIG. 6C is a schematic diagram of an optical member driving mechanism according to another embodiment of the invention;

FIG. 7 is a bottom view of the optical member driving mechanism according to an embodiment of the invention;

FIG. 8 is a schematic diagram of an optical member driving mechanism according to another embodiment of the invention;

FIG. 9 is a schematic diagram of an optical member driving mechanism according to another embodiment of the invention; and

FIG. 10 is a schematic diagram of an optical member driving mechanism according to another embodiment of the invention.

### DETAILED DESCRIPTION OF INVENTION

The making and using of the embodiments of the optical member driving mechanism are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

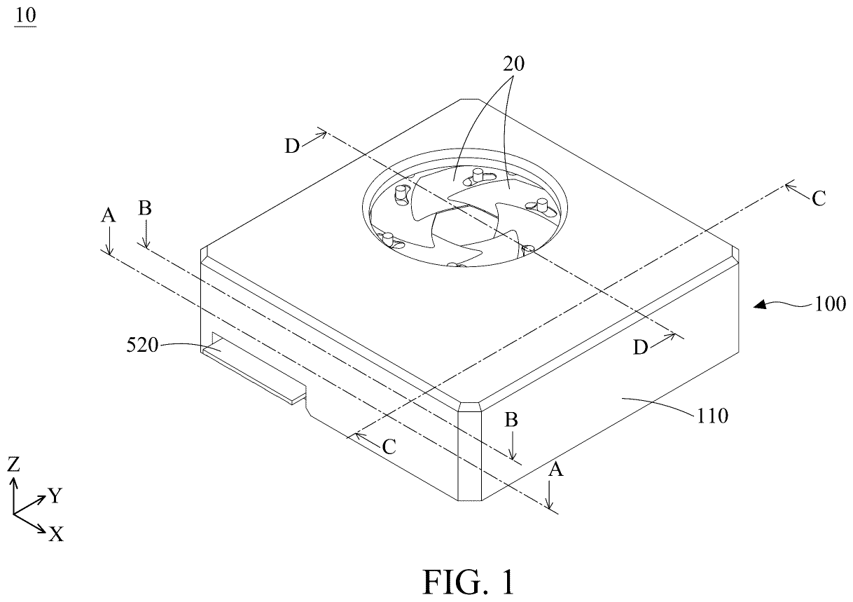

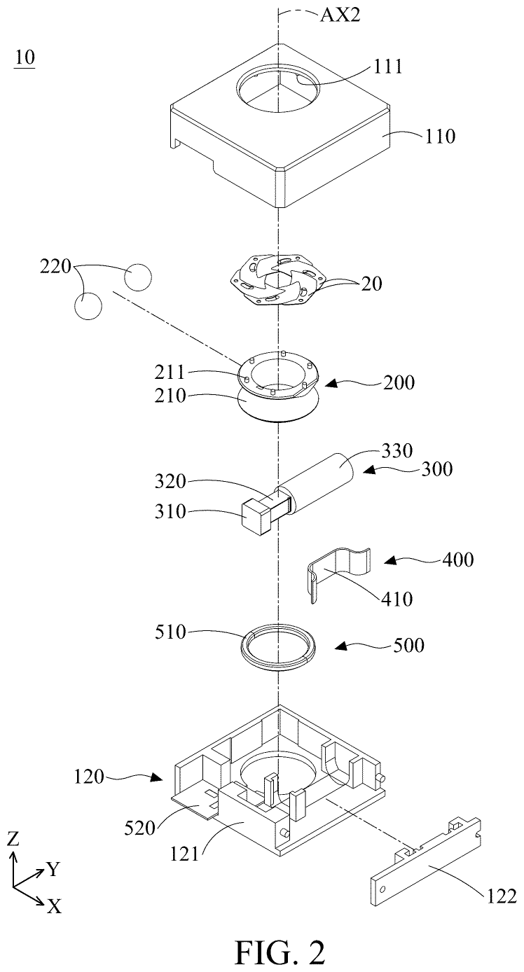

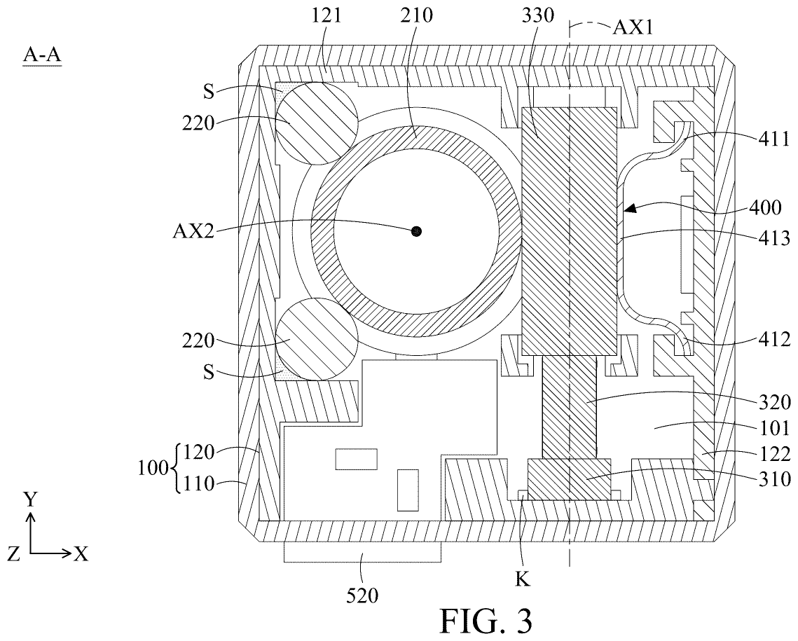

FIG. 1 is a schematic diagram of an optical member driving mechanism 10, FIG. 2 is an exploded-view diagram of the optical member driving mechanism 10, and FIG. 3 is a cross-sectional view taken along the line A-A in FIG. 1. As shown in FIG. 1 to FIG. 3, a plurality of optical members 20 can be connected to the optical member driving mechanism 10, the optical member driving mechanism 10 can drive the optical members to rotate, so that the region of the optical member driving mechanism 10 which the external light is able to pass can be controlled. For example, the optical member driving mechanism 10 can be disposed above a camera lens or an image sensor, and can be used as an aperture.

The optical member driving mechanism 10 primarily includes a fixed portion 100, a movable portion 200, a driving assembly 300, a pressing assembly 400, and a position sensing assembly 500. The fixed portion 100 includes a cover 110 and a base 120, and they can be engaged to form a box. The movable portion 200, the driving assembly 300, and the pressing assembly 400 can be accommodated in the inner space 101 of the box, so as to prevent them from impacting with the external components and causing damage. The base 120 includes a main body 121 and a lateral plate 122, they can be detachably joined to each other, so as to facilitate the assemble of the movable portion 200, the driving assembly 300, and the pressing assembly 400.

The movable portion 200 includes a rotary member 210 and two positioning balls 220. The rotary member 210 can be connected to the fixed portion 100 via the positioning balls 220 and the driving assembly 300, and can be rotate around a second axis AX2 relative to the fixed portion 100. The positioning balls 220 can be disposed on the fixed portion 100, and can be in contact with the fixed portion 100 and the rotary member 210.

In particular, the points of contact of two positioning balls 220 and the rotary member 210 and the point of contact of the driving assembly 300 and the rotary member 210 can substantially form an equilateral triangle or an isosceles triangle, so that the rotary member 210 can be clamped and hanged in the inner space 101 of the fixed portion 100. In this embodiment, the optical member driving mechanism 10 can further includes soft members S. The soft members S are filled between the inner wall of the fixed portion 100 and the positioning balls 220, and are in contact with them, so as to ensure the contact between the positioning balls 220 and the rotary member 210. For example, the soft members S can include sponge or foam, but it is not limited thereto.

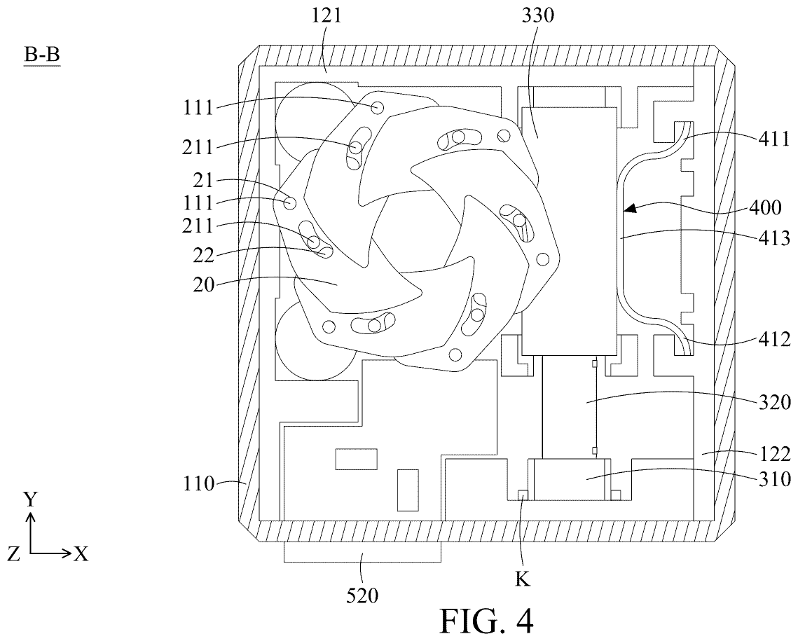

As shown in FIG. 2 to FIG. 4, the cover 110 has a plurality of fixing pillars 111 extending toward the rotary member 210, and the rotary member 210 has a plurality of guiding pillars 211 extending toward the opposite direction. Each optical member 20 has a shaft hole 21 and a guiding slot 22. The fixing pillar 111 passes the shaft hole 21, and the guiding pillar 211 passes the guiding slot 22. The diameter of the shaft hole 21 is substantially the same as the diameter of the fixing pillar 111, and the dimensions of the guiding slot 22 is greater than the dimensions of the guiding pillar 211. Therefore, when the rotary member 210 rotates relative to the fixed portion 100, the fixing pillar 111 can be used as a rotary shaft, the guiding pillar 211 can move along the guising slot 22, and the optical member 20 can be driven to rotate around the fixing pillar 111.

Referring to FIG. 1 to FIG. 3, the driving assembly 300 includes a weight member 310, a piezoelectric member 320, and a transmitting member 330. The piezoelectric member 320 is disposed between the weight member 310 and the transmitting member 330, and the weight member 310, the piezoelectric member 320, and the transmitting member 330 are arranged along a first axis AX1 in sequence. The first axis AX1 is substantially perpendicular to the second axis AX2.

The weight member 310 is disposed on the fixed portion 100. The piezoelectric member 320 is connected to the weight member 310. The transmitting member 330 is connected to the piezoelectric member 320 and in contact with the rotary member 210 of the movable portion 200. The piezoelectric 320 can be deformed along the first axis AX1, and the mass of the weight member 310 is greater than the mass of the piezoelectric member 320 and the mass of the transmitting member 330. Therefore, when the driving assembly 300 is operated, the piezoelectric member 320 is primarily deformed along the first axis AX1 toward the transmitting member 330. Thus, the transmitting member 300 shifts and provides a driving force to the rotary member 210 to allow the rotary member 210 to rotate around the second axis AX2.

For example, the weight member 310 can include tungsten or other suitable metal, the piezoelectric member 320 can include ceramic, quartz, or other suitable material, and the transmitting member 330 can include carbon fiber or other suitable material.

Moreover, it should be noted that, the weight member 310 is not rigidly affixed to the fixed portion 100 by the screws, the rivets, or the hard glue. On the contrary, the weight member 310 is attached to the fixed portion 100 by the soft glue K. Therefore, the driving effect of the driving assembly 300 can be increased.

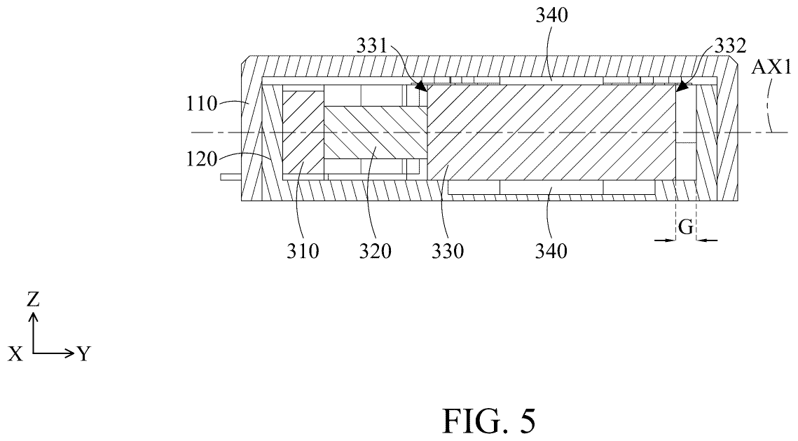

Referring to FIG. 3 to FIG. 5, the transmitting member 330 has a first end 331 and a second end 332. The first end 331 is connected to the piezoelectric member 320, and the second end 332 is opposite to the first end 331. A gap G is formed between the second end 332 and the wall of the fixed portion 100, so as to prevent the transmitting member 330 from impacting the fixed portion 100 and being damage during the movement. The upper side and the lower side of the transmitting member 330 can be connected to the fixed portion 100 by the soft members 340, and the driving assembly 300 can be prevented from being inclined relative to the first axis AX1 due to the weight of the members or the oscillation. The soft members 340 are disposed between the first end 331 and the second end 332, so that the soft members 340 do not affect the driving effect of the driving assembly 300.

The soft members 340 can include silica gel or mucilage glue, but it is not limited thereto.

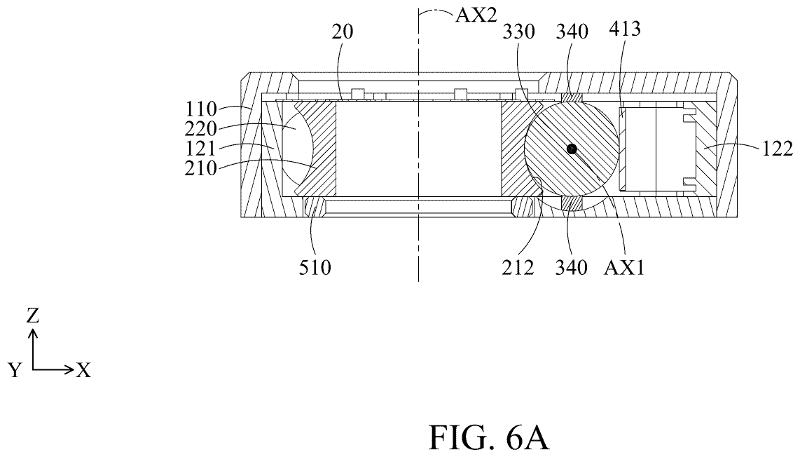

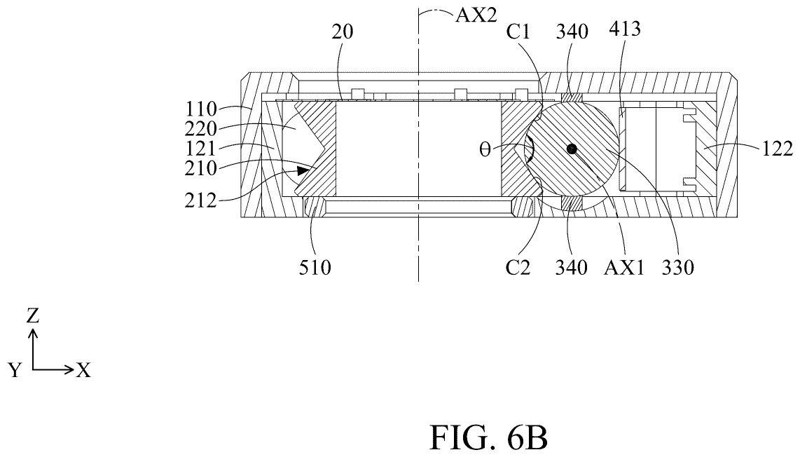

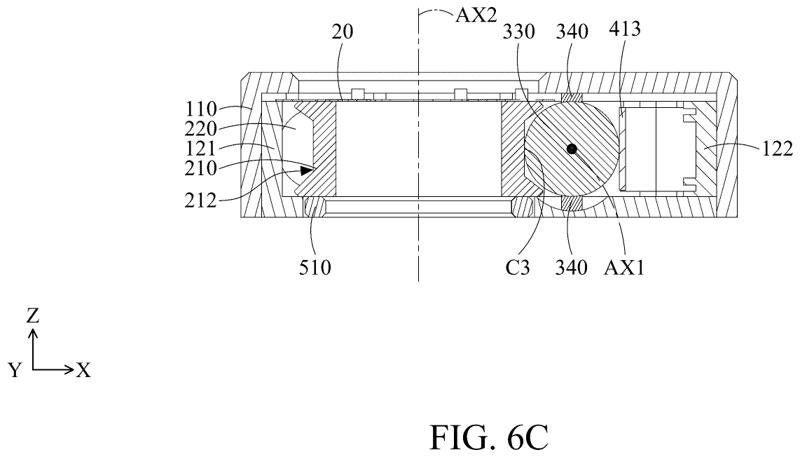

Referring to FIG. 6A, in this embodiment, the transmitting member 330 has a circular cross-section, the rotary member 210 has a concave structure 212, and the concave structure 212 has an arc-shaped cross-section. The radius of curvature of the arc-shaped cross-section of the concave structure 212 is greater than that of the circular cross-section of the transmitting member 330. Therefore, when the optical member driving mechanism 10 is assembled, a portion of the transmitting member 330 is accommodated in the concave structure, and the transmitting member 330 and the rotary member 210 are in contact with each other at a single point of contact.

Referring to FIG. 6B, in some embodiments, the concave structure 212 of the rotary member 210 has a first inclined surface C1 and a second inclined surface C2. An included angle θ that is less than 180° is formed between the first inclined surface C1 and the second inclined surface D2. When the optical member driving mechanism 10 is assembled, the transmitting member 330 is in contact with the first inclined surface C1 at a point of contact, and is in contact with the second inclined surface C2 at another point of contact. Since the contact point is increased, the stability and the effect of the transmitting member 330 for driving the rotary member 210 to rotate can be enhanced.

Referring to FIG. 6C, in some embodiments, the concave structure 212 of the rotary member 210 has a contact surface C3. The contact surface C3 is a flat surface that is parallel to the second axis AX2. When the optical member driving mechanism 10 is assembled, the transmitting member 300 and the contact surface C3 are in contact with each other at a single point of contact.

As shown in FIG. 1 to FIG. 3, the pressing assembly 400 includes a pressing member 410. The pressing member 410 can be a sheet metal spring. The pressing member 410 includes a first fixing end 411, a second fixing end 412, and a contact section 413. The first fixing end 411 and the second fixing end 412 are affixed to the lateral plate 122 of the base 120 of the fixed portion 100. The contact section 413 is in contact with the transmitting member 330 of the driving assembly 300.

During the assembly of the optical member driving mechanism 10, the movable portion 200 and the driving assembly 300 can be disposed on the base 120 from the position above the main body 121 of the base 120. Subsequently, the lateral plate 122 with the pressing member 410 can be laterally engaged with the main body 121. When the lateral plate 122 is engaged with the main body 121, the pressing member 410 is in contact with the transmitting member 330, and provides a pushing force to the transmitting member 330 by its elastic force to keep the transmitting member 330 and the rotary member 210 to be in contact with each other. The direction of the aforementioned pushing force is substantially perpendicular to the first axis AX1 and the second axis AX2.

In this embodiment, in the first axis AX1, the contact section 413 is situated between the first fixing end 411 and the second fixing end 412, and the contact section 413 has a flat surface. Therefore, the contact section 413 and the transmitting member 330 can be in contact with each other in a line.

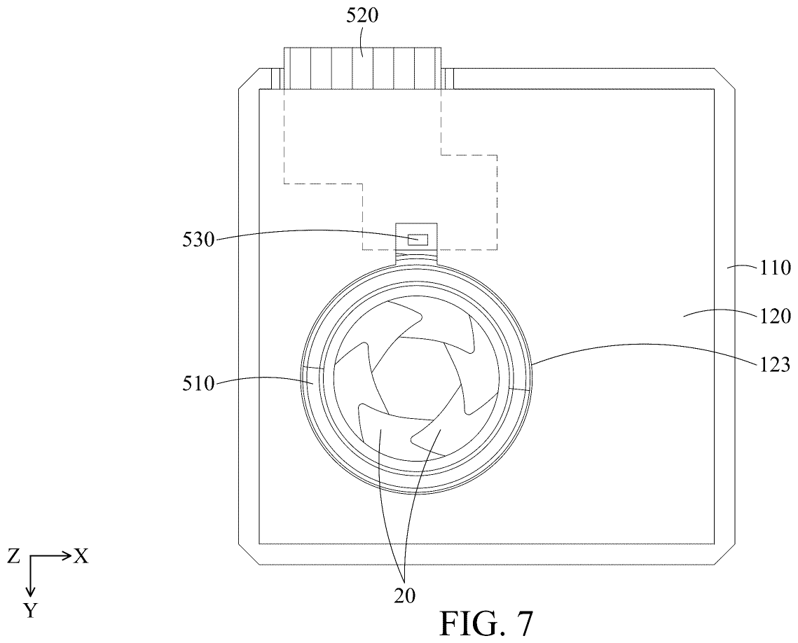

Referring to FIG. 2 and FIG. 7, the position sensing assembly 500 includes an annular magnetic member 510, a circuit board 520, and a sensor 530. The annular magnetic member 510 is connected to the lower side of the rotary member 210 of the movable portion 200. The circuit board 520 is disposed on the base 120 of the fixed portion 100. The sensor 530 is disposed on the circuit board 520 and is situated at a side of the annular magnetic member 510.

The sensor 530 can obtain the orientation of the rotary member 210 relative to the fixed portion 100 by detecting the change of the magnetic field of the annular magnetic member 510. For example, the sensor 530 can include a Hall sensor, a magnetoresistance effect sensor (MR sensor), a giant magnetoresistance effect sensor (GMR sensor), a tunneling magnetoresistance effect sensor (TMR sensor), or a fluxgate sensor, but it is not limited thereto.

In this embodiment, the base 120 of the fixed portion 100 has an opening 123, and the annular magnetic member 510 and the sensor 530 are exposed from the opening 123, so that the miniaturization of the optical member driving mechanism 10 can be achieved.

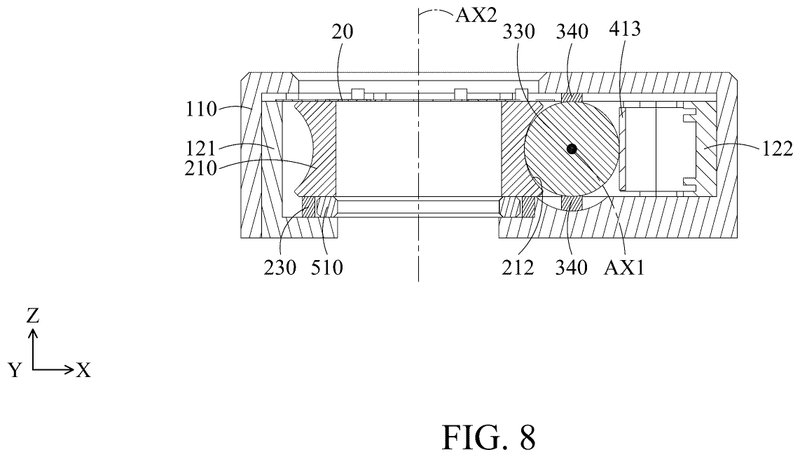

Referring to FIG. 8, in some embodiments of the invention, the positioning balls of the movable portion 200 can be omitted, and the movable portion 200 can further includes a bearing 230. The bearing 230 is connected to the rotary member 210 and the fixed portion 100. Therefore, the rotary member 210 is rotatable relative to the fixed portion 100, and the movement of the rotary member 210 relative to the fixed portion 100 when the optical member driving mechanism 10 oscillates can be avoided.

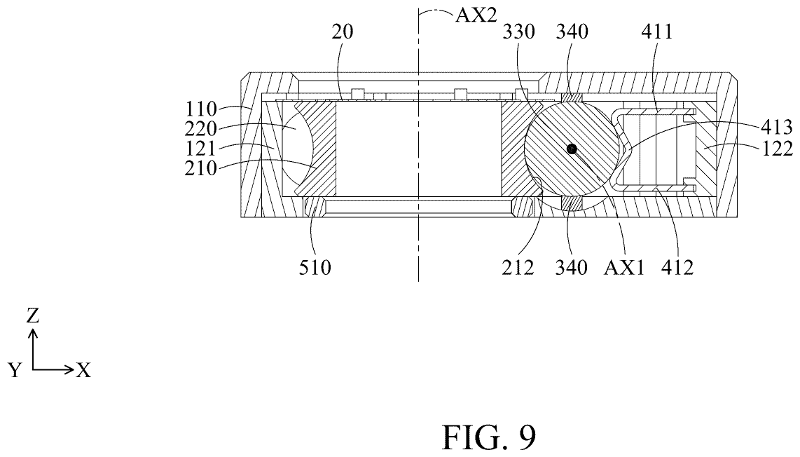

Referring to FIG. 9, in another embodiment of the invention, the first fixing end 411, the contact section 413, and the second fixing end 412 of the pressing member 410 are arranged along the second axis AX2 in sequence. This, in the second axis AX2, the contact section 413 is situated between the first fixing end 411 and the second fixing end 412. The contact section 413 has a V-shaped structure. When the optical member driving mechanism 10 is assembled, the contact section 413 and the transmitting member 330 are in contact with each other in two parallel lines.

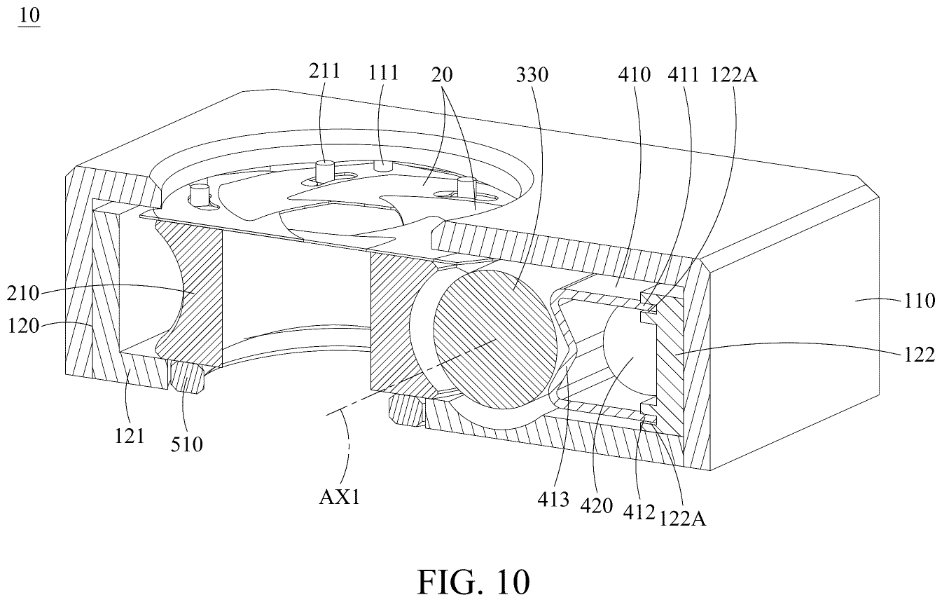

Referring to FIG. 10, in another embodiment of the invention, the first fixing end 411 and the second fixing end 412 of the pressing member 410 are movably connected to the fixed portion 100, and the pressing assembly 400 can further includes a ball member 420 that is in contact with the contact section 413 of the pressing member 410 and the lateral plate 122 of the base 120. In detail, the lateral plate 122 has two guiding slots 122A along the first axis AX1, and the first fixing end 411 and the second fixing end 412 are respectively slidably disposed in these two guiding slots 122A. Therefore, when the driving assembly 300 starts to drive, the pressing member 410 moves as the transmitting member 330 moves.

The features between the aforementioned embodiments can be used or combined as long as they do not violate the spirit or conflict.

In summary, an embodiment of the invention provides an optical member driving mechanism, including a movable portion, a fixed portion, and a driving assembly. The movable portion is configured to connect an optical member, and is movable relative to the fixed portion. The driving assembly is configured to drive the movable portion to move.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An optical member driving mechanism, comprising:
a movable portion, configured to connect an optical member;
a fixed portion, wherein the movable portion is movable relative to the fixed portion; and
a driving assembly, configured to drive the movable portion to move.

2. The optical member driving mechanism as claimed in claim 1, wherein the driving assembly comprises a piezoelectric member, the piezoelectric member is deformed along a first axis when operating, and the driving assembly drives the movable portion to rotate around a second axis, wherein the second axis is different from the first axis.

3. The optical member driving mechanism as claimed in claim 2, wherein the second axis is substantially perpendicular to the first axis.

4. The optical member driving mechanism as claimed in claim 2, wherein the driving assembly further comprises:
a weight member, disposed on the fixed portion; and
a transmitting member, wherein the piezoelectric member is disposed between the weight member and the transmitting member, the piezoelectric member is connected to the weight member, and the transmitting member is connected to the piezoelectric member,
wherein the optical member driving mechanism further comprises a pressing assembly, the pressing assembly is connected to the fixed portion and in contact with the transmitting member, and the pressing assembly provides a pushing force to allow the transmitting member to make contact with the movable portion.

5. The optical member driving mechanism as claimed in claim 4, wherein a direction of the pushing force is different from the first axis and the second axis.

6. The optical member driving mechanism as claimed in claim 5, wherein the direction of the pushing force is substantially perpendicular to the first axis and the second axis.

7. The optical member driving mechanism as claimed in claim 4, wherein the pressing assembly comprises a pressing member, the pressing member comprises a first fixing end, a second fixing end, and a contact section, the first fixing end and the second fixing end are connected to the fixed portion, and the contact section is in contact with the transmitting member, wherein in the first axis, the contact section is situated between the first fixing end and the second fixing end.

8. The optical member driving mechanism as claimed in claim 4, wherein the pressing assembly comprises a pressing member, the pressing member comprises a first fixing end, a second fixing end, and a contact section, the first fixing end and the second fixing end are connected to the fixed portion, and the contact section is in contact with the transmitting member, wherein in the second axis, the contact section is situated between the first fixing end and the second fixing end.

9. The optical member driving mechanism as claimed in claim 8, wherein the first fixing end and the second fixing end are movably connected to the fixed portion.

10. The optical member driving mechanism as claimed in claim 9, wherein the pressing assembly further comprises a ball member that is in contact with the contact section and the fixed portion.

11. The optical member driving mechanism as claimed in claim 4, wherein the transmitting member has a circular cross-section, and the pressing assembly has a flat surface that is in contact with the transmitting member.

12. The optical member driving mechanism as claimed in claim 4, wherein the transmitting member comprises a first end and a second end, the first end is connected to the piezoelectric member, the second end is opposite to the first end, and a gap is formed between the second end and the fixed portion.

13. The optical member driving mechanism as claimed in claim 12, wherein the optical member driving mechanism further comprises a soft member connected to the transmitting member and the fixed portion, and the soft member is disposed between the first end and the second end.

14. The optical member driving mechanism as claimed in claim 4, wherein the movable portion has a concave structure, the concave structure has an arc-shaped cross-section, and a radius of curvature of the arc-shaped cross-section of the concave structure is greater than a radius of curvature of the transmitting member.

15. The optical member driving mechanism as claimed in claim 4, wherein the movable portion has a first inclined surface and a second inclined surface, an included angle is formed between the first inclined surface and the second inclined surface, and the included angle is less than 180 degrees, wherein the transmitting member is in contact with the first inclined surface at a point of contact, and the transmitting member is in contact with the second inclined surface at another point of contact.

16. The optical member driving mechanism as claimed in claim 4, wherein the movable portion has a contact surface, the contact surface is parallel to the second axis, and the transmitting member is in contact with the contact surface at a point of contact.

17. The optical member driving mechanism as claimed in claim 2, wherein the movable portion comprises a rotary member and at least two positioning balls, and the positioning balls are connected to the fixed portion and the rotary member.

18. The optical member driving mechanism as claimed in claim 17, wherein the optical member driving mechanism further comprises a plurality of soft members that are in contact with the positioning balls and the fixed portion.

19. The optical member driving mechanism as claimed in claim 2, wherein the movable portion comprises a rotary member and a bearing, and the bearing is connected to the fixed portion and the rotary member.

20. The optical member driving mechanism as claimed in claim 2, wherein the optical member driving mechanism further comprises a position sensing assembly, and the position sensing assembly comprises:
an annular magnetic member, connected to the movable portion;
a circuit board, disposed on the fixed portion; and
a sensor, disposed on the circuit board and situated at a side of the annular magnetic member, wherein the fixed portion has an opening, and the annular magnetic member and the sensor are exposed from the opening.
